(19) United States
(12) Patent Application Publication
(10) Pub. No.: US 2009/0108219 A1
(43) Pub. Date: Apr. 30, 2009

(54) Zone valve actuator

(76) Inventor: Michael R. Schreiner, Cedarburg, WI (US)

Correspondence Address: RYAN KROMHOLZ & MANION, S.C., POST OFFICE BOX 26618, MILWAUKEE, WI, 53226, US

(21) Appl. No.: 11/977,819

(22) Filed: Oct. 26, 2007

(51) Int. Cl. F16K 31/02

(52) U.S. Cl. 251/129.1; 251/129.12

(57) ABSTRACT

A valve actuator includes a motor which drives a gear assembly for selectively imparting motion to a valve member. The valve actuator includes a reed switch for use in controlling a pump or control system for a plurality of pumps in response to initialization of the valve actuator. The motion of the gear assembly causes a magnetic field to come into contact with the reed switch and either engage or disengage the reed switch.

### BACKGROUND OF THE INVENTION

The present invention relates a valve actuator. The valve actuator is designed to be coupled to a valve body to operate the valve. The actuator assembly includes a motor and a drive mechanism engaged with the valve stem of the valve, such that operation of the motor functions to impart rotation to the valve stem to control the position of the valve member within the interior of the valve body. The valve actuator includes an “end switch” or “auxiliary switch” which is typically used to switch signals for controls.

### SUMMARY OF THE INVENTION

The present invention provides a valve actuator including a housing, a motor having an output, a magnet, and a reed switch.

In one embodiment valve actuator includes a drive gear which is coupled to the motor output. In an additional embodiment, the magnet is coupled to the drive gear. The drive gear may be movable between a first position and a second position. In the first position the magnet may be adjacent the reed switch. In the first position the magnetic field produced by the magnet may be in operable communication with the reed switch.

The invention provides a method of operating a valve actuator including providing a valve actuator with a motor, a magnet and a reed switch and operating the valve actuator to bring the magnet into operable communication with the reed switch.

In one embodiment valve actuator includes a drive gear and the motor includes an output drive gear and the output drive gear is coupled to the drive gear. The magnet may be coupled to the drive gear. The operating step may include moving the drive gear from a first position to a second position. In the first position the magnet may be adjacent the reed switch. In the first position the magnetic field produced by the magnet may be in operable communication with the reed switch.

### BRIEF DESCRIPTION OF THE DRAWINGS

FIG. 1 is a perspective view of an embodiment of a valve actuator in accordance with the present invention, the valve actuator coupled to a valve body.

FIG. 2 is an exploded perspective view of the valve actuator of FIG. 1.

FIG. 3 is an exploded perspective view of the base portion of the valve actuator of FIG. 1.

FIG. 3A is a perspective view of a reed switch for use in the valve actuator of FIG. 1.

FIGS. 4 and 5 are a cross sectional view of the valve actuator of FIG. 1 in the open and closed positions.

FIG. 6 is a partial perspective view of the valve actuator of FIG. 2 showing the engagement of the reed switch.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

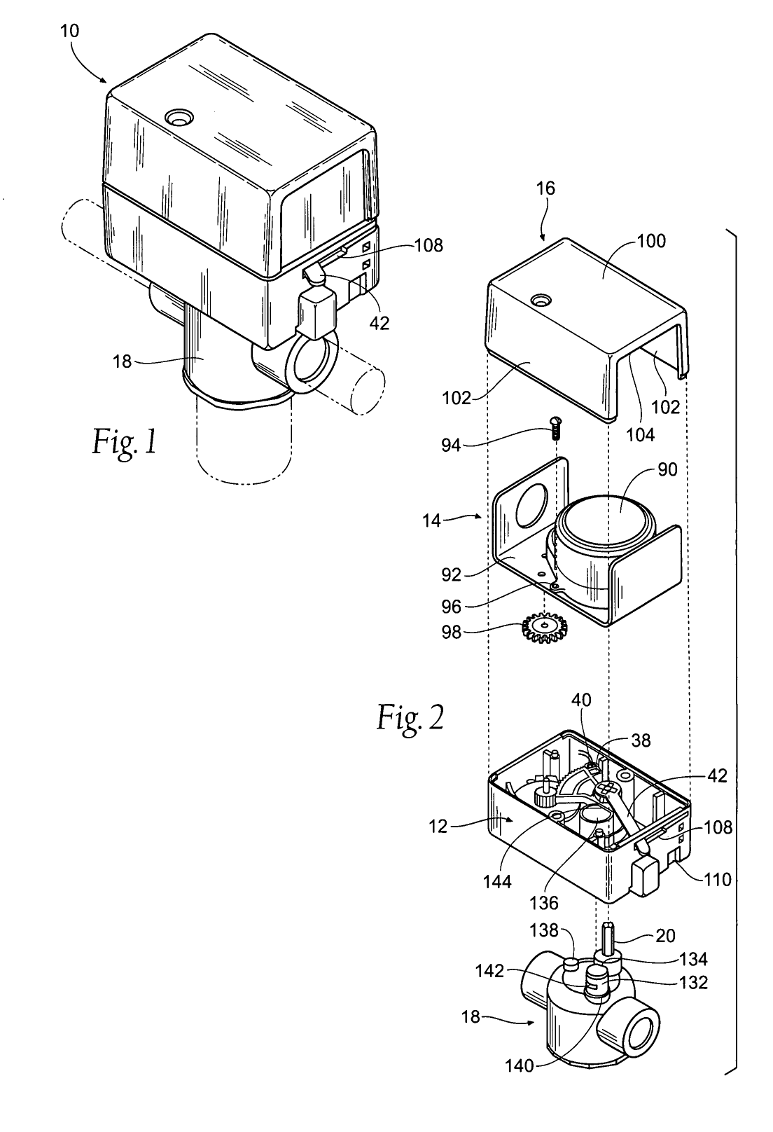

A zone valve actuator 10 in accordance with the present invention is shown in FIG. 2. The valve actuator 10 includes a base section 12, a motor section 14, and a cover 16. The valve actuator 10 is adapted to be coupled to the valve body 18 as shown in FIG. 1. In the illustrated embodiment, the valve actuator 10 is releasably coupled to the valve body 18; however it is also contemplated that the valve actuator 10 may be permanently secured to the valve body 18. The valve actuator 10 is operable to selective move the valve member 20 of the valve body 18 between its open and closed positions.

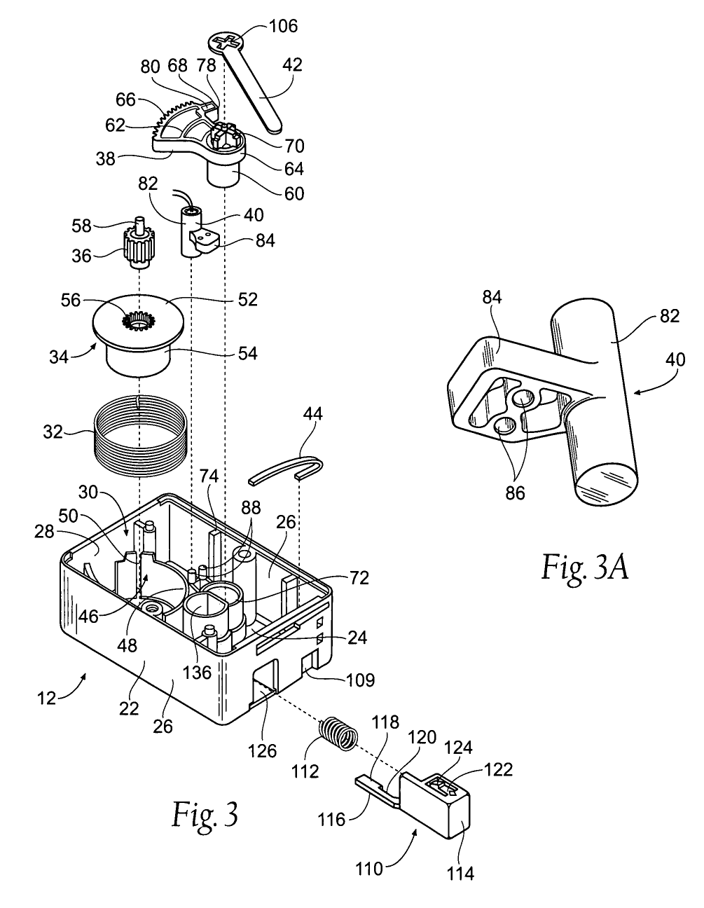

As seen in the illustrated embodiment shown in FIG. 3, the base section 12 includes a base section housing 22 having a bottom wall 24, a pair of side walls 26, and a pair of end walls 28 which form an internal cavity 30. The base section 12 further includes a generally arcuate wall 48 that extends upwardly from the bottom wall 24 to define a pinion housing cavity 46. The base section 12 may further include a tubular gear mounting boss that extends upwardly form the bottom wall 24 and defines an internal passage that opens onto the exterior of the base section housing 22 bottom wall 24.

A series of components are engaged within the base section housing 22 as shown in FIG. 3. These components include a torsion spring 32, a pinion housing 34 adapted to mount a pinion 36, a sector gear 38, and a reed switch 40. The base section housing 22 may optionally include a manual overdrive lever 42 and associated leaf spring 44.

A torsion spring 32 is preferably fixed in position in the pinion housing cavity 46 by any known means. In the illustrated embodiment, the torsion spring 32 is fixed in place by placing the end portion of the torsion spring 32 into a slot 50 formed in the arcuate wall 48.

Still referring to FIG. 3, the pinion housing 34 preferably includes an upper disc portion 52 and a lower annular side wall 54 extending downwardly from an upper disc portion 52. A slot (not shown) may be formed in the annular side wall 54, and is adapted to receive an inwardly extending end portion formed at the upper end of the torsion spring 32, so as to engage the torsion spring 32 with the pinion housing 34. The pinion housing 34 includes an annular toothed recess 56 at its center, which is configured so as to mate with the lower end of the pinion 36. The recess 56 terminates in an upwardly facing shoulder which engages a downwardly facing edge defined by the gear teeth of the pinion 36, to fix the axial position of the pinion 36 relative to the pinion housing 34. The pinion 36 includes an upwardly extending center pin 58.

After assembly of the torsion spring 32, the pinion housing 34 and the pinion 36 into the pinion housing cavity 46, as shown in FIG. 3, the torsion spring 32 is wound to a predetermined torque in a known manner, such as via a manufacturing fixture which accesses the pinion housing 34 from an opening formed in the bottom wall 24.

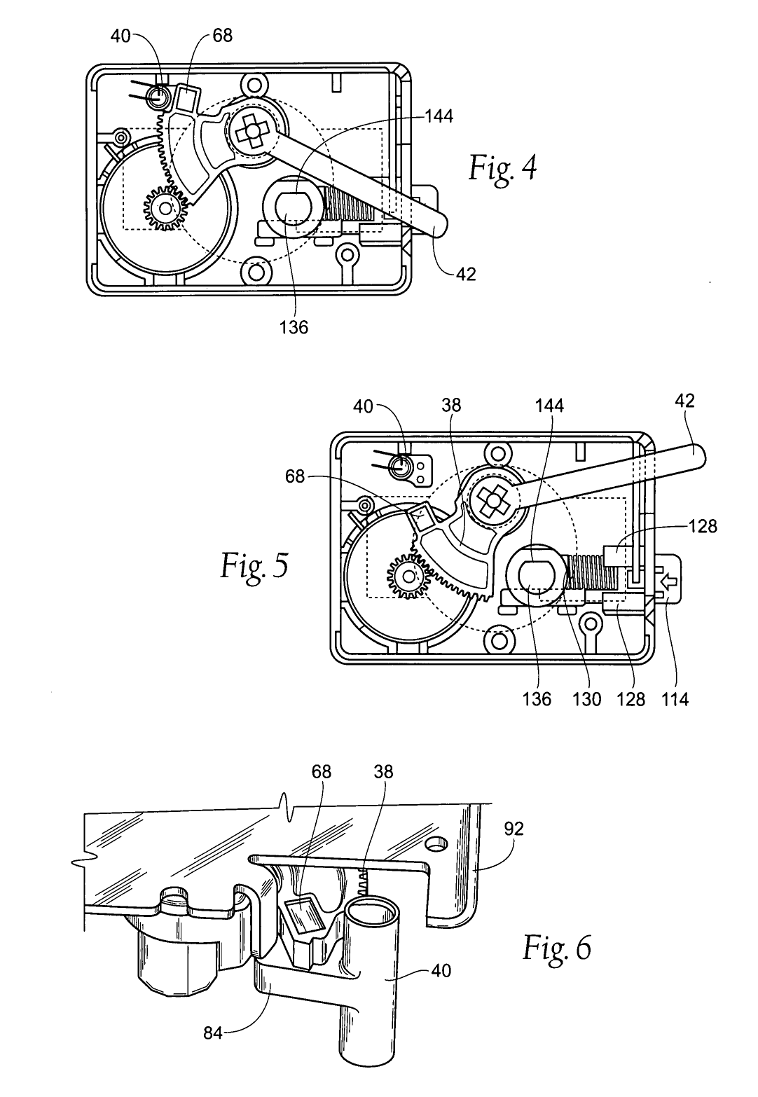

Referring to FIG. 4, in the illustrated embodiment, the sector gear 38 includes a mounting hub 60 and a sector gear body 62 including an central section 64 and a gear edge 66 on which a plurality of gear teeth are formed. A stop lug 68 extends from one side of the sector gear body 62, and an X-shaped boss 70 extends upwardly from the central section 64. The teeth of the sector gear 38 are engaged with the teeth of the pinion 36. With this arrangement, the sector gear 38 is pivotable about a pivot axis defined by the longitudinal axis of the hub 60, which is coincident with the longitudinal axis of the gear mounting boss 72 which is formed to the bottom surface 24 of the base section housing 22. The stop lug 68 is selectively engagable with a stop rib 74 that extends inwardly from the base section side wall 26, to selectively stop rotation of the sector gear 38 in a clockwise direction.

The sector gear hub 60 includes a downwardly facing internal passage (not shown) having a cross sectional configuration which matches that of the valve stem 20. In this manner the rotation of the sector gear 38 will cause rotation of the valve stem 20.

As shown in FIG. 3, a magnet 80 is attached to the sector gear 38. In the illustrated embodiment, a cavity 78 is formed on the stop lug 68 portion of the sector gear 38 and the magnet is disposed within the cavity 78. However it is contemplated that the magnet could be coupled to the sector gear 38 using any known means.

A reed switch 40 is disposed within the base section 12. The reed switch 40 preferably operates as an end switch or auxiliary switch to switch low current signals for auxiliary controls. The reed switch 40 is contained within a capsule. The capsule includes a generally cylindrical portion 82 and an integrally formed tab 84 which extends generally perpendicular to the cylindrical portion 82. A pair of spaced apart passages 86 are formed on one surface of the tab 84, as shown in FIG. 3A. The reed switch 40 capsule is assembled to a pair of mounting studs 88 formed integrally formed to the bottom wall 24 of the base section 12 housing 22 by engaging the pair of spaced apart passages 86 formed in the tab 84 of reed switch 40 capsule.

The “end switch” or “auxiliary switch” is generally used to switch low currents. Typically, these switches would be standard micro switches. However, switching low current can cause problems with standard micro switches because there isn't enough current to “scrub” the contacts. This is an especially big problem in environments where contaminants can reach the contacts of the switch. It is therefore desirable to provide a zone valve actuator that does not use a standard micro switch.

Reed switches generally include a pair of magnetizable and electrically conductive metal reeds. The reeds are hermetically sealing in opposite ends of a generally glass capsule. A magnetic field from either an electromagnet or a magnet will cause the contacts to either pull together or move apart. In a normally open reed switch the end portions of the reeds are separated by a small gap when the switch is open. These end postions pull together completing the electrical circuit when a magnetic field is applied. The stiffness of the reeds causes them to separate when the magnetic field ceases, this opening the circuit.

In a normally closed reed switch, the end portions of the reeds are generally in contact. These end portions pull apart when a magnetic field is applied, thus opening the circuit. The stiffness of the reeds causes them to pull together when the magnetic field ceases, thus closing the circuit.

Reed switches have momentary action. Not only do reed switches react quickly, but the contacts revert back to the original state as soon as the magnetic field diminishes. For this reason reed switches have historically been used in high speed switching application, such as telecommunications. Furthermore, reed switches are known to have a long life. In other words, the reed switch can be switched on and off many times before failing.

In the situation of a valve actuator, the switch does not need to have a very fast reaction time, therefore it would not be excepted to use a reed switch in this application. It is heretofore unknown to use a reed switch as an auxiliary switch in a valve actuator application.

In the illustrated embodiment, a motor 90 drives the sector gear 38. In the illustrated embodiment, the motor 90 is coupled to a motor mounting member which takes the form of a mounting plate 92 with upwardly extending walls at opposite ends. Fasteners 94, such as screws, are inserted through openings in mounting tabs 96 associated with the housing of motor 90, to secure the mounting plate 92 and the motor 90 together to the base section 12. In this manner, the mounting plate 92 functions to simultaneously enclose the internal cavity 30 of the base section 12, and to retain various components such as the sector gear 38, the pinion 36 (and pinion housing 36) and a manual lever 42 in position within the internal cavity 30 of the base section 12, as well as to mount the motor 90 to the base section 12. However, it is contemplated that other configurations and means could be utilized to secure the motor 90 to the base section 12 housing 22. In the illustrated embodiment the mounting plate preferably includes a bent tab 76, as shown in FIG. 6 to hold the reed switch 40 in place.

In the illustrated embodiment, the motor 90 includes an output drive gear (not shown) which may engages the gear teeth of a lost motion gear 98 that is engaged with a pin 58 which extends upwardly from the pinion 36 as is known in the art. However, it is contemplated that any combination and configuration of gears could be utilized to drive the sector gear 38. FIG. 4 shows the sector gear 38 in a first position, while FIG. 5 shows the sector gear 38 in a second position.

As shown in FIG. 2, the illustrated embodiment includes a cover 16. The cover 16 includes a top wall 100, a pair of side walls 102, and a pair of end walls 104. The cover 16 may be assembled after the motor section 14 is secured to the base section 12. In the illustrated embodiment the cover 16 may be secured by a fastener 92 extending through the top wall 100 of the cover 16 into the mounting plate 92. It is also contemplated that various engaging devices could be formed in the base section housing 22 and the cover 16, including but not limited to mating pegs and recesses.

It may be desirable to provide the valve actuator 10 with means for manually opening the valve 18. As shown in FIG. 3, in the illustrated embodiment, the means for manually opening the valve 18 comprises a manual open lever 42 engaged with the sector gear 38. In the illustrated embodiment, the manual open lever 42 is engaged with the sector gear 38 via an X-shaped opening 106 which receives an X-shaped boss 70 at the central section 64 of the sector gear 38. The lever 42 extends outwardly through a slot 108 in the end wall 28 of the base section 12. In the illustrated embodiment a wire form spring 44 is engaged with an upper edge defined by an indentation 109, and bears against the downwardly facing surface of the lever 42 for providing an upward bias on the lever 42. FIG. 4 shows the valve actuator 10 including the manual lever 42 in the open position. FIG. 5 shows the valve actuator 10, including the manual lever 42 in the closed position.

The valve actuator 10 is preferably releasably engagable with the valve body 18 via a latch mechanism as is known in the art. The latch mechanism may include a latch member 110 and a latch member spring 112 as shown in FIG. 3.

The latch member 110 includes an outer actuator portion 114 and an inwardly extending latch arm 118 which includes a blocking member 118 at its end. A recess 120 is located between the blocking member 118 and the rear end of the actuator portion 114. The top wall of the actuator portion 114 is formed with a resilient finger 122 having an outwardly extending tang 124. In assembly, the outer end of the spring 112 is first engaged with the rear wall of the outer actuator portion 114. The latch member 110, with spring 112 mounted thereto, is then inserted through opening 126 in end wall 28 of base section 12. A pair of guide walls 128 (seen in FIG. 5), extend inwardly from the inside surface of the end wall 28, and are configured to match the cross section of actuator portion 114 so as to facilitate inward and outward movement of the actuator portion 114 relative to end wall 28.

As latch member 110 is engaged within the opening 126 in this manner, the tang 124 comes into contact with the upper edge of the end wall 28, which functions to deflect the finger 122 inwardly. Upon continued inward movement of the actuator portion 114, the tang 124 clears the inside surface of the end wall 28 and the finger 122 is moved outwardly under the influence of its outward bias, to return the tang 124 to its original position. The outer lip of the tang 124 is thus located above the upper edge of the opening 126, to interfere with the end wall 28 so as to maintain the latch member 110 in engagement with base section 12. The inner end of the spring 112 bears against a spring bearing surface 130 (see FIG. 5).

The spring 112 has a length and configuration which functions to bias the latch member 110 outwardly to place the latch member 110 in a latching position in which latch member is placed in a latched position. In the latched position the tang 124 engages the inside surface of end wall 28 so as to maintain latch member 110 in engagement with base section 12.

Latch member 110 is movable between a latching position and a release position, by movement of latch member 110 outwardly and inwardly, respectively, relative to base section 12 end wall 28.

The valve actuator 10 may be installed on a valve body 18 as known in the art. Specifically, to install the valve actuator 10 on a valve body 18, the user manually engages outer actuator portion 114 of the latch member 110, and applies an inward force to the latch member 110 so as to move the latch member 110 from its engaged position to its release position against the bias of the spring 112.

When the latch member 110 is placed in its release position in this manner, the recess 120 of the latch arm 116 is located in a receiver slot (not shown), such that the latch arm 116 does not interfere with the passage of the receiver 136. The user may then engage the valve stem 20 within the passage defined by the sector gear hub 72, and align the valve actuator 10 relative to the valve body 18 by placing the flat wall 144 of the receiver 136 into alignment with the flat side area 134 of the valve body mounting post 132.

While continuing to maintain the latch member 96 in its release position by manual engagement with the outer actuator portion 114 of the latch member 100, the user moves the valve actuator 10 toward the valve body 18 in a direction parallel to the longitudinal axes of the mounting post 132 and the valve stem 20. Such movement of the valve actuator 10 functions to continue movement of the valve stem 20 into the passage in the sector gear hub 72, and movement of the mounting post 132 into the passage of the receiver 136. When the valve actuator 10 is fully engaged with the valve body 18 in this manner, the lower surface of the bottom wall 24 engages a stop member 138, shown at, defined by valve body 18, as well as an upwardly facing shoulder 140, shown at, defined by the valve stem mounting post 132. The user then releases the manual engagement of the outer actuator portion 114 of the latch member 110, and the spring 112 extends so as to place the latch member 110 in its engaged position.

When the latch member 110 is in its engaged position, the blocking member 118 of the latch arm 116 is received within the slot 142 in the mounting post 132. When the latch member 110 is placed in its latching position in this manner, engagement of the blocking member 118 within the slot 142 prevents the valve actuator 10 from being removed from the valve body 18.

When the valve actuator 10 is installed on a valve body 18, operation of the valve actuator 10 is generally the same as in the prior art so as to provide movement of the valve member 20 of the valve body 18.

In the illustrated embodiment, a motor 90 is operated to impart movement to a sector gear 38 through a lost motion gear 98, however as described above an alternative combination or configuration of gears could be utilized. In a two-way valve, the stop lug 68 engages the stop rib 74 to control the range of movement of the valve member 20 in one direction, and internal engagement of the valve member 20 with the valve seat (not shown) controls movement of the valve member 20 in the opposite direction. In a three-way valve, internal engagement of the valve member 20 with the valve seats controls movement of the valve in both directions.

The torsion spring 32 applies a normally open or closed bias, by urging the pinion housing 36 in either a clockwise or counterclockwise direction, according to the desired operation of the valve actuator 10.

The reed switch 40 functions to initiate operation of a circulating pump or a control system for controlling operation of a series of pumps, in response to initiation of operation of valve actuator 10.

Referring now to FIGS. 4 and 5, as described above, a magnet 80 is attached to the sector gear 38. As the sector gear 38 rotated, as described above, the magnetic field created by the magnet is moved into position adjacent the reed switch 40. Depending on the application, the reed switch 40 may be normally open, and close when a magnetic field is applied, or the reed switch 40 may be normally closed and open when a magnetic field is applied. It is contemplated that the magnet 80 does not need to be touching the reed switch 40. Rather, the magnet 80 is adjacent the reed switch 40 such that the magnetic field of the magnet 80 is in operable communication with the reed switch 40. This operable communication activates the reed switch 40 to either close or open depending on the configuration of the reed switch 40.

The illustrated embodiment shows a stationary reed switch 40 and a movable magnet 80, the magnet 80 being movable because the magnet 80 is coupled, indirectly, to the motor 90 output. However, it is also contemplated that the reed switch 40 could be coupled to the sector gear 38 and thus be movable while the magnet 80 is stationary. In this embodiment the reed switch 40 would be coupled, either directly or in directly, to the motor 90 output.

It is also contemplated that the motor 90 output could be directly connected to the valve stem 20, eliminating the motor output drive gear (not shown), the lost motion gear 98 and the sector gear 32. In the case the magnet 80 would be coupled, either directly or indirectly to the motor 90 output.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/We claim:

1. A valve actuator comprising:
a housing;
a motor disposed in the housing, the motor having an output;
a magnet disposed in the housing; and
a reed switch disposed in the housing.

2. The valve actuator of claim 1 further comprising a drive gear, said drive gear being coupled to the motor output.

3. The valve actuator of claim 2 wherein the magnet is coupled to the drive gear.

4. The valve actuator of claim 3 wherein the drive gear is movable between a first position and a second position.

5. The valve actuator of claim 4 wherein the magnet is adjacent the reed switch at the drive gear first position.

6. The valve actuator of claim 4 wherein the magnet has a magnetic field, the magnetic field being in operable communication with the reed switch in the drive gear first position.

7. The valve actuator of claim 4 wherein the drive gear is coupled to the motor output drive gear through a lost motion gear.

8. A method comprising:
providing a valve actuator including a housing, and a motor, a magnet and a reed switch disposed within the housing; and
operating said valve actuator to bring the magnet into operable communication with the reed switch.

9. The method of claim 8 wherein said motor includes a motor output and the magnet is coupled to the motor output.

10. The method of claim 9 wherein said magnet is indirectly coupled to the motor output.

11. The method of claim 8 wherein said valve actuator further includes a drive gear.

12. The method of claim 11 wherein said motor includes an output drive gear, said output drive gear being coupled to said drive gear.

13. The method of claim 12 wherein said magnet is coupled to the drive gear.

14. The method of claim 13 wherein said operating step further comprises moving the drive gear from a second position to a first position.

15. The method of claim 14 wherein the drive gear first position comprises a position in which the magnet is adjacent the reed switch.

16. The method of claim 14 wherein said magnet produces a magnetic field.

17. The method of claim 16 wherein the drive gear first position comprises a position in which the magnetic field is in operable communication with the reed switch.
